(19) United States
(12) Patent Application Publication
(10) Pub. No.: US 2012/0055509 A1
(43) Pub. Date: Mar. 8, 2012

(54) CLEANING CONTACT CLEANING ROLLERS

(75) Inventor: Sheila Hamilton, Kilmacolm (GB)

(73) Assignee: ITW CS (UK) LIMITED, London (GB)

(21) Appl. No.: 13/254,848

(22) PCT Filed: Mar. 3, 2010
(86) PCT No.: PCT/GB10/50372

§ 371 Date: Nov. 4, 2011

(30) Foreign Application Priority Data
Mar. 5, 2009 (GB) 0903799.5

(51) Int. Cl. B08B 1/00; B08B 7/00

(52) U.S. Cl. 134/6

(57) ABSTRACT

There is herein described an improved method for cleaning contact cleaning rollers. More particularly, there is described an improved method for cleaning contact cleaning rollers using a cleaning surface comprising lyophilic and hydrophilic microfibers.

### FIELD OF THE INVENTION

The present invention relates to an improved method for cleaning contact cleaning rollers. More particularly, the present invention relates to an improved method for cleaning contact cleaning rollers using a cleaning surface comprising lyophilic and hydrophilic microfibers.

### BACKGROUND OF THE INVENTION

Contact cleaning in conjunction with adhesive rollers is commonly used to clean substrate surfaces in the manufacture of electronic components. For example, we refer to WO 99/24178, WO 2007/034244 and WO 2008/041000, which are incorporated herein by reference.

During contact cleaning, elastomer cleaning rollers are usually kept clean by an adhesive roller making contact with the elastomer cleaning roller and removing debris such as small contaminating particles. However, an existing problem is that although the adhesive roller will remove debris from the elastomer cleaning roller, lyophilic deposits such as oil-based material (e.g. grease) will remain on the elastomer cleaning roller. The elastomer cleaning roller may also become contaminated with debris and oil-based deposits (e.g. grease) when removed for maintenance.

Current practice within the industry is to remove the lyophilic deposits such as the oil-based material using a fabric wipe saturated in iso-propanol or any other suitable hydrocarbon solvent. Alternatively, some manufacturers advocate the use of water to clean the rollers but unless surfactants are used the water will not remove grease. A significant problem with this method is that surfactants will remain on the surface of the elastomer cleaning roller after it is dried and can transfer to the surface being cleaned. This can lead to the manufactured electronic components being contaminated and resulting in faulty electronics.

A further problem is that many users of contact cleaning do not like using solvents as these are hazardous and highly flammable materials. Many solvents such as iso-propanol are also prohibited substances in some countries. It is an object of at least one aspect of the present invention to obviate or mitigate at least one or more of the aforementioned problems.

It is a further object of at least one aspect of the present invention to provide an improved method for cleaning contact cleaning rollers.

It is a further object of at least one aspect of the present invention to provide an improved method for cleaning contact cleaning rollers using a cloth comprising lyophilic and hydrophilic microfibers.

It is a yet further object of at least one aspect of the present invention to provide an improved method for cleaning contact cleaning rollers and removing debris and lyophilic deposits such as oil-based material (e.g. grease).

### SUMMARY OF THE INVENTION

According to a first aspect of the present invention there is provided a method of cleaning contaminated contact cleaning rollers, said method comprising:

providing a cleaning surface comprising lyophilic and hydrophilic microfibers;

urging the cleaning surface and the lyophilic and hydrophilic microfibers against the contaminated contact cleaning rollers;

wherein the cleaning surface removes oil-based contaminating based material and contaminating particles from the contaminated contact cleaning rollers.

The present invention therefore relates to using the cleaning surface to remove hydrocarbon based material and contaminating particles such as loose debris from a contaminated surface and/or surfaces of the contact cleaning roller.

The cleaning surface may be made from any suitable material such as a porous (e.g. microporous) and/or flexible material. The material may be a woven or a non-woven fabric. The cleaning surface may be made from a microfiber based material such as a cloth.

Typically, the cleaning surface may comprise a plurality of lyophilic and lyophobic microfibers. The microfibers may be made lyophilic or lyophobic by manufacturing the fibers from lyophilic or lyophobic material, respectively. Alternatively, the fibers may be soaked in lyophilic or lyophobic material to produce fibers impregnated and/or coated with lyophilic and/or lyophobic material.

The fibers making up the microfibers on the cleaning surface may be fine fibers on the micro-scale such as about 0.01-100 μm, about 0.1-10 μm or about 5 μm in length.

The lyophilic microfibers may be used to collect and/or remove oil-based contaminating material such as hydrocarbon based material (e.g. grease) as well as contaminating particles such as loose debris. The lyophilic fibers may attract oil-based contaminating material and therefore clean the surface and/or surfaces of the contact cleaning roller. For example, the lyophilic fibers may be used to remove grease marks from the contaminated contact cleaning rollers. The hydrocarbon based material may be C₁₀-C₃₀ hydrocarbons. The elastomer cleaning rollers may additionally become contaminated with debris and oil-based deposits (e.g. grease) when removed for maintenance and the process as defined in the present invention is highly suitable for this purpose. By lyophilic is meant having a strong affinity for hydrocarbon based material such as oils (e.g. grease).

The lyophilic microfibers provide a dual function in that not only do they have a chemical action by removing the hydrocarbon based material using a strong affinity for such material but they also provide a mechanical scraping action. The mechanical scraping action may therefore also be used to remove debris from contaminated surfaces of the contact cleaning rollers.

The lyophobic microfibers also facilitate the cleaning process by providing, for example, a mechanical scraping action to remove debris from contaminated surfaces of the contact cleaning rollers. The lyophobic microfibers may be used to attract materials other than hydrocarbon based material. By lyophobic is meant having a strong affinity against hydrocarbon based material such as oils (e.g. grease).

The cleaning surface (e.g. a cloth) may be slightly dampened with water which may facilitate the cleaning process.

It has been found that the cleaning surface as defined in the present invention may be specifically useful for removing oil-based material (e.g. grease) and debris (e.g. loose particles) from the contact cleaning rollers. This overcomes problems in present cleaning methods which use fabric wipes saturated in iso-propanol or any other suitable hydrocarbon solvent. Surfactants are also commonly used but these remain on the surface of the cleaning roller after it is dried and can transfer to the surface being cleaned. This can lead to problems in manufactured electronic components. The present invention therefore overcomes the problems in the prior art and provided a quick and easy way in which to clean the cleaning rollers.

Moreover, the cleaning surface as defined in the present invention may be advantageously useful for cleaning a micro-structured surface on a cleaning roller.

The cleaning surface may therefore be used to clean contact cleaning rollers which are contaminated with microscopically sized contaminating particles and oil-based material. For example, the microscopically sized particles may comprise have a cross-sectional diameter ranging from any one of or combination of the following: less than about 10 microns (10,000 nm); less than about 5 microns (5,000 nm); less than about 1 micron (1,000 nm); less than about 0.1 microns (100 nm); less than about 0.01 micron (10 nm); or less than about 0.005 micron (5 nm). Alternatively, the microscopically sized contaminating particles may have a cross-sectional diameter ranging from any one of or combination of the following: about 1 nm to about 10 microns (10,000 nm); about 10 nm to about 10 microns (10,000 nm); about 10 nm to about 1 micron (1,000 nm); about 10 nm to about 0.1 microns (100 nm); or about 1 nm to about 0.01 microns (10 nm).

In particular, the cleaning as defined in the present invention may be used in cleaning surfaces which are intended to be used in the manufacturing process to form electronic components such as plastic electronics, photovoltaics and flat panel displays.

According to a second aspect of the present invention there is provided use of a cleaning surface comprising lyophilic and hydrophilic microfibers in cleaning a contaminated contact cleaning roller; said use comprising:

urging the cleaning surface comprising lyophilic and hydrophilic microfibers against the contaminated contact cleaning roller;

wherein the cleaning surface removes oil-based contaminating material and contaminating particles from the contaminated contact cleaning roller.

The cleaning surface may be made from any suitable material such as a porous (e.g. microporous) and/or flexible material. The material may be a woven or a non-woven fabric. The cleaning surface may be made from a microfiber based material such as a cloth.

Typically, the cleaning surface may comprise a plurality of lyophilic and lyophobic microfibers. The microfibers may be made lyophilic or lyophobic by manufacturing the fibers from lyophilic or lyophobic material, respectively. Alternatively, the fibers may be soaked in lyophilic or lyophobic material to produce fibers impregnated and/or coated with lyophilic and/or lyophobic material.

The fibers making up the microfibers on the cleaning surface may be fine fibers on the micro-scale such as about 0.01-100 μm, about 0.1-10 μm or about 5 μm in length.

The lyophilic microfibers may be used to collect and/or remove oil-based contaminating material such as hydrocarbon based material (e.g. grease) as well as contaminating particles such as loose debris. The lyophilic fibers may attract oil-based contaminating material and therefore clean the surface and/or surfaces of the contact cleaning roller. For example, the lyophilic fibers may be used to remove grease marks from the contaminated contact cleaning rollers. The hydrocarbon based material may be C₁₀-C₃₀ hydrocarbons. The elastomer cleaning rollers may additionally become contaminated with debris and oil-based deposits (e.g. grease) when removed for maintenance and the process as defined in the present invention is highly suitable for this purpose. By lyophilic is meant having a strong affinity for hydrocarbon based material such as oils (e.g. grease).

The lyophilic microfibers provide a dual function in that not only do they have a chemical action by removing the hydrocarbon based material using a strong affinity for such material but they also provide a mechanical scraping action. The mechanical scraping action may therefore also be used to remove debris from contaminated surfaces of the contact cleaning rollers.

The lyophobic microfibers also facilitate the cleaning process by providing, for example, a mechanical scraping action to remove debris from contaminated surfaces of the contact cleaning rollers. The lyophobic microfibers may be used to attract materials other than hydrocarbon based material. By lyophobic is meant having a strong affinity against hydrocarbon based material such as oils (e.g. grease).

The cleaning surface (e.g. a cloth) may be slightly dampened with water which may facilitate the cleaning process.

It has been found that the cleaning surface as defined in the present invention may be specifically useful for removing oil-based material (e.g. grease) and debris (e.g. loose particles) from the contact cleaning rollers. This overcomes problems in present cleaning methods which use fabric wipes saturated in iso-propanol or any other suitable hydrocarbon solvent. Surfactants are also commonly used but these remain on the surface of the cleaning roller after it is dried and can transfer to the surface being cleaned. This can lead to problems in manufactured electronic components. The present invention therefore overcomes the problems in the prior art and provides a quick and easy way in which to clean the cleaning rollers.

Moreover, the cleaning surface as defined in the present invention may be advantageously useful for cleaning a micro-structured surface on a cleaning roller.

The cleaning surface may therefore be used to clean contact cleaning rollers which are contaminated with microscopically sized contaminating particles and oil-based material. For example, the microscopically sized particles may comprise have a cross-sectional diameter ranging from any one of or combination of the following: less than about 10 microns (10,000 nm); less than about 5 microns (5,000 nm); less than about 1 micron (1,000 nm); less than about 0.1 microns (100 nm); less than about 0.01 micron (10 nm); or less than about 0.005 micron (5 nm). Alternatively, the microscopically sized contaminating particles may have a cross-sectional diameter ranging from any one of or combination of the following: about 1 nm to about 10 microns (10,000 nm); about 10 nm to about 10 microns (10,000 nm); about 10 nm to about 1 micron (1,000 nm); about 10 nm to about 0.1 microns (100 nm); or about 1 nm to about 0.01 microns (10 nm).

In particular, the cleaning as defined in the present invention may be used in cleaning surfaces which are intended to be used in the manufacturing process to form electronic components such as plastic electronics, photovoltaics and flat panel displays.

### BRIEF DESCRIPTION OF THE DRAWINGS

Embodiments of the present invention will now be described, by way of example only, with reference to the accompanying drawings in which:

FIG. 1 is a representation of surface cleaning apparatus.

### BRIEF DESCRIPTION

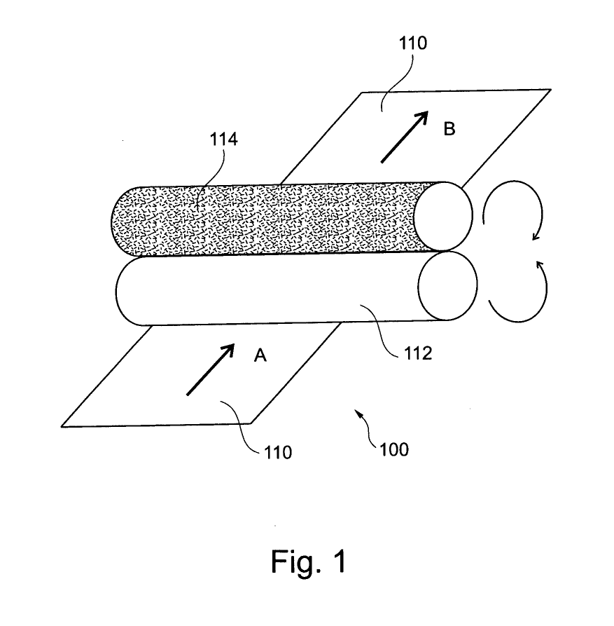

FIG. 1 is a representation of surface cleaning apparatus according to the prior art, generally designated 100. As shown in FIG. 1 the surface cleaning apparatus 100 comprises a contact cleaning roller 112 and an adhesive roller 114. The contact cleaning roller 112 collects and removes contaminated material from substrate 110. Urging means (not shown) force the substrate 110 against the contact cleaning roller 112. As shown in FIG. 1, the contact cleaning roller 112 counter-rotates against the adhesive roller 114 which removes contaminated particles formed on the contact cleaning roller 112. During this process hydrocarbon based material may be transferred onto the contact cleaning roller 112 as well as contaminating particles such as loose debris. The contact cleaning roller may additionally become contaminated with debris and oil-based deposits (e.g. grease) when removed for maintenance and the process as defined in the present invention is highly suitable for cleaning this material.

The region identified by reference ‘A’ in the substrate 110 is therefore uncleaned and the region identified by reference ‘B’ is cleaned and may then be used in the manufacture of electronic components such as plastic electronics, photovoltaics and flat panel displays.

The present invention relates to a method of cleaning a contaminated contact cleaning roller. The contaminated contact cleaning roller may be urged (e.g. wiped) against the cleaning surface which removes lyophilic based material from the contaminated contact cleaning rollers. The present invention therefore relates to using the cleaning surface to remove lyophilic based material from a contaminated surface and/or surfaces of the contact cleaning roller.

The cleaning surface is made from a porous (e.g. microporous) and/or flexible material. The material is a woven or a non-woven fabric. The cleaning surface is made from a microfiber based material such a cloth.

The cleaning surface comprises a plurality of lyophilic and lyophobic microfibers. The lyophilic fibers are used to collect and/or remove oil-based contaminating material such as hydrocarbon based material. For example, the lyophilic fibers are used to remove grease marks from the contaminated contact cleaning rollers.

The lyophilic microfibers provide a dual function in that not only do they have a chemical action by removing the hydrocarbon based material using a strong affinity for such material but they also provide a mechanical scraping action. The mechanical scraping action is used to remove loose debris from contaminated surfaces of the contact cleaning rollers.

The lyophobic microfibers also facilitate the cleaning process by providing, for example, a mechanical scraping action to remove debris from contaminated surfaces of the contact cleaning rollers.

The cleaning surface such as from, for example, a cloth may be slightly dampened with water which facilitates the cleaning process.

It has been found that the cleaning surface is specifically useful for removing oil-based material (e.g. grease) and debris (e.g. loose particles) from the contact cleaning rollers.

Moreover, the cleaning surface is advantageously useful for cleaning a micro-structured surface on a cleaning roller.

The cleaning surface as defined in the present invention is therefore useful in cleaning contact cleaning rollers which are contaminated with microscopically sized particles and oil-based material. For example, the microscopically sized particles have a cross-sectional diameter ranging from any one of or combination of the following: less than about 10 microns (10,000 nm); less than about 5 microns (5,000 nm); less than about 1 micron (1,000 nm); less than about 0.1 microns (100 nm); less than about 0.01 micron (10 nm); or less than about 0.005 micron (5 nm). Alternatively, the microscopically sized particles have a cross-sectional diameter ranging from any one of or combination of the following: about 1 nm to about 10 microns (10,000 nm); about 10 nm to about 10 microns (10,000 nm); about 10 nm to about 1 micron (1,000 nm); about 10 nm to about 0.1 microns (100 nm); or about 1 nm to about 0.01 microns (10 nm).

Whilst specific embodiments of the present invention have been described above, it will be appreciated that departures from the described embodiments may still fall within the scope of the present invention. For example, any suitable type of cleaning surface may be used to clean contaminated contact cleaning rollers. The contamination may be caused by any type of hydrocarbon based material and/or debris.

1. A method of cleaning contaminated contact cleaning rollers, said method comprising: providing a cleaning surface comprising lyophilic and hydrophilic microfibers; urging the cleaning surface and the lyophilic and hydrophilic microfibers against the contaminated contact cleaning rollers; wherein the cleaning surface removes oil-based contaminating material and contaminating particles from the contaminated contact cleaning rollers.

2. A method of cleaning contaminated contact cleaning rollers according to claim 1, wherein the cleaning surface is made from a porous (e.g. microporous) and/or flexible material.

3. A method of cleaning contaminated contact cleaning rollers according to claim 1, wherein the cleaning surface is made from a woven or a non-woven fabric.

4. A method of cleaning contaminated contact cleaning rollers according to claim 1, wherein the cleaning surface is a microfiber based cloth.

5. A method of cleaning contaminated contact cleaning rollers according to claim 1, wherein the cleaning surface comprises a plurality of lyophilic and lyophobic microfibers.

6. A method of cleaning contaminated contact cleaning rollers according to claim 1, wherein the microfibers are made lyophilic or lyophobic by manufacturing the fibers from lyophilic or lyophobic material, respectively.

7. A method of cleaning contaminated contact cleaning rollers according to claim 1, wherein the fibers are soaked in lyophilic or lyophobic material to produce fibers impregnated and/or coated with lyophilic and/or lyophobic material.

8. A method of cleaning contaminated contact cleaning rollers according to claim 1, wherein the microfibers on the cleaning surface are fine fibers on the micro-scale of about 0.01-100 μm, about 0.1-10 μm or about 5 μm in length.

9. A method of cleaning contaminated contact cleaning rollers according to claim 1, wherein the lyophilic microfibers are used to collect and/or remove oil-based contaminating material such as hydrocarbon based material (e.g. grease) as well as contaminating particles such as loose debris.

10. A method of cleaning contaminated contact cleaning rollers according to claim 1, wherein the lyophilic microfibers attract oil-based contaminating material and therefore clean the surface and/or surfaces of the contact cleaning roller.

11. A method of cleaning contaminated contact cleaning rollers according to claim 1, wherein the lyophilic fibers are used to remove grease marks from the contaminated contact cleaning rollers.

12. A method of cleaning contaminated contact cleaning rollers according to claim 1, wherein the lyophilic microfibers provide a dual function in that not only do they have a chemical action by removing hydrocarbon based material using a strong affinity for such material but they also provide a mechanical scraping action.

13. A method of cleaning contaminated contact cleaning rollers according to claim 1, wherein the lyophobic microfibers also facilitate the cleaning process by providing a mechanical scraping action to remove debris from contaminated surfaces of the contact cleaning rollers.

14. A method of cleaning contaminated contact cleaning rollers according to claim 1, wherein the lyophobic microfibers are used to attract materials other than hydrocarbon based material.

15. method of cleaning contaminated contact cleaning rollers according to claim 1, wherein the cleaning surface is slightly dampened with water to facilitate the cleaning process.

16. A method of cleaning contaminated contact cleaning rollers according to any claim 1, wherein the cleaning surface is useful for cleaning a micro-structured surface on a cleaning roller.

17. A method of cleaning contaminated contact cleaning rollers according to claim 1, wherein the cleaning surface is used to clean contact cleaning rollers which are contaminated with microscopically sized contaminating particles having a cross-sectional diameter ranging from any one of or combination of the following: less than about 10 microns (10,000 nm); less than about 5 microns (5,000 nm); less than about 1 micron (1,000 nm); less than about 0.1 microns (100 nm); less than about 0.01 micron (10 nm); or less than about 0.005 micron (5 nm).

18. A method of cleaning contaminated contact cleaning rollers according to claim 1, wherein the cleaning surface is used to clean contact cleaning rollers which are contaminated with microscopically sized contaminating particles having a cross-sectional diameter ranging from any one of or combination of the following: about 1 nm to about 10 microns (10,000 nm); about 10 nm to about 10 microns (10,000 nm); about 10 nm to about 1 micron (1,000 nm); about 10 nm to about 0.1 microns (100 nm); or about 1 nm to about 0.01 microns (10 nm).

19. Use of a cleaning surface comprising lyophilic and hydrophilic microfibers in cleaning a contaminated contact cleaning roller; said use comprising: urging the cleaning surface comprising lyophilic and hydrophilic microfibers against the contaminated contact cleaning roller; wherein the cleaning surface removes oil-based contaminating material and contaminating particles from the contaminated contact cleaning roller.
